(19) United States
(12) Patent Application Publication
(10) Pub. No.: US 2026/0098606 A1
(43) Pub. Date: Apr. 9, 2026

(54) PRESSURE VESSEL

(71) Applicant: TOYOTA JIDOSHA KABUSHIKI KAISHA, Toyota-shi (JP)

(72) Inventors: Osamu SAWAI, Okazaki-shi (JP); Yuki KAI, Nagoya-shi (JP); Youjirou IRIYAMA, Toyota-shi (JP); Asei SATO, Ichinomiya-shi (JP)

(73) Assignee: TOYOTA JIDOSHA KABUSHIKI KAISHA, Toyota-shi (JP)

(21) Appl. No.: 19/337,021

(22) Filed: Sep. 23, 2025

(30) Foreign Application Priority Data
Oct. 8, 2024 (JP) 2024-176691

(51) Int. Cl. F17C 1/00

(52) U.S. Cl. CPC F17C 1/00; F17C 2201/0128; F17C 2201/0138; F17C 2201/0157

(57) ABSTRACT

A pressure vessel for fluid includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series. A cross-sectional shape of the bent portion perpendicular to an extension direction is a shape in which a dimension in a third direction orthogonal to the first direction and the second direction is larger than a dimension in a fourth direction orthogonal to the third direction.

### CROSS-REFERENCE TO RELATED APPLICATION

This application claims priority to Japanese Patent Application No. 2024-176691 filed on Oct. 8, 2024. The disclosure of the above-identified application, including the specification, drawings, and claims, is incorporated by reference herein in its entirety.

### BACKGROUND

### 1. Technical Field

The technique disclosed in the present specification relates to a pressure vessel.

### 2. Description of Related Art

Japanese Unexamined Patent Application Publication (Translation of PCT Application) No. 2018-519480 (JP 2018-519480 A) discloses a pressure vessel for fluid. The pressure vessel includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series. The cross-sectional shape perpendicular to the extension direction of the main body portion and the cross-sectional shape perpendicular to the extension direction of the bent portion are circular.

### SUMMARY

In the pressure vessel of JP 2018-519480 A, the bent portion is provided by bending a linear tubular portion. Therefore, in order to make it easier to provide the bent portion, the area of the cross section perpendicular to the extension direction of the bent portion is smaller than the area of the cross section perpendicular to the extension direction of the main body portion. In the pressure vessel including the bent portion, it is desirable to increase the amount of fluid that is able to be filled into the pressure vessel.

The present specification provides a technique that is able to increase the amount of fluid that is able to be filled into a pressure vessel.

In a first aspect disclosed in the present specification, a pressure vessel for fluid is disclosed. The pressure vessel includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series. A cross-sectional shape of the bent portion perpendicular to an extension direction is a shape in which a dimension in a third direction orthogonal to the first direction and the second direction is larger than a dimension in a fourth direction orthogonal to the third direction.

According to the above configuration, the cross-sectional area of the bent portion is able to be made larger than in a configuration in which the cross-sectional shape perpendicular to the extension direction of the bent portion is circular and the diameter of the circle is the same as the dimension of the cross-sectional shape of the bent portion in the third direction. Therefore, it is possible to increase the amount of fluid that is able to be filled into the pressure vessel. Hereinafter, the circle with a diameter that is the same as the dimension of the cross-sectional shape of the bent portion in the third direction will be referred to as a “specific circle”.

In a second aspect, in the first aspect, the cross-sectional shape may be oval or elliptical.

According to the above configuration, it is possible to increase the amount of fluid that is able to be filled into the pressure vessel, compared to a configuration in which the cross-sectional shape of the bent portion is the specific circle.

In a third aspect, in the first aspect, the cross-sectional shape may be rectangular.

According to the above configuration, it is possible to increase the amount of fluid that is able to be filled into the pressure vessel, compared to a configuration in which the cross-sectional shape of the bent portion is the specific circle.

In a fourth aspect, another pressure vessel for fluid is disclosed. A pressure vessel includes a plurality of main body portions, each having a tubular shape extending along a first direction and disposed along a second direction orthogonal to the first direction, and one or more bent portions, each having a tubular shape, extending between two adjacent end portions of the main body portions, and connecting the main body portions in series. A cross-sectional shape of the bent portion perpendicular to an extension direction is a square shape in which a dimension in a third direction orthogonal to the first direction and the second direction is equal to a dimension in a fourth direction orthogonal to the third direction.

According to the above configuration, the cross-sectional area of the bent portion is able to be made larger than in the configuration in which the cross-sectional shape of the bent portion is the specific circle. Therefore, it is possible to increase the amount of fluid that is able to be filled into the pressure vessel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a top view of a pressure vessel 2;

FIG. 2 is a cross-sectional view of a bent portion 12;

FIG. 3 shows the pressure vessel before the bent portion 12 is provided;

FIG. 4 shows a comparison of cross-sectional areas;

FIG. 5 is a cross-sectional view of a bent portion 212 of the pressure vessel 2 according to a second embodiment; and

FIG. 6 is a cross-sectional view of a bent portion 312 of the pressure vessel 2 according to a third embodiment.

### DETAILED DESCRIPTION OF EMBODIMENTS

### First Embodiment

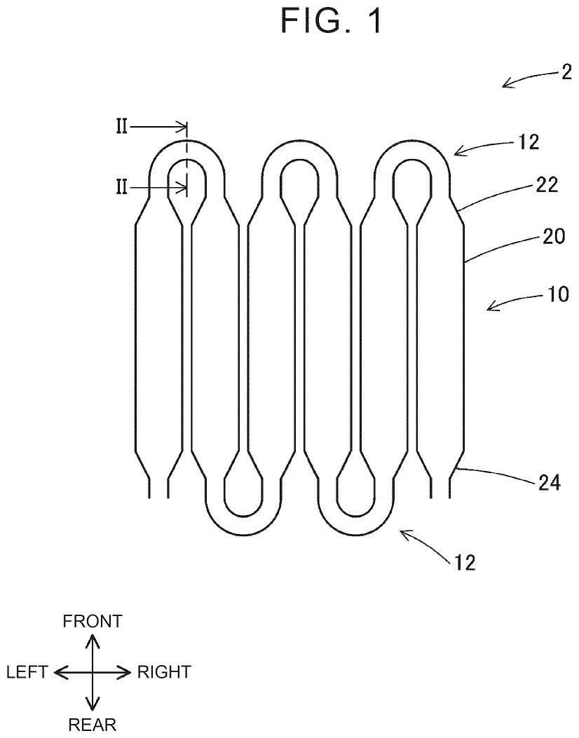

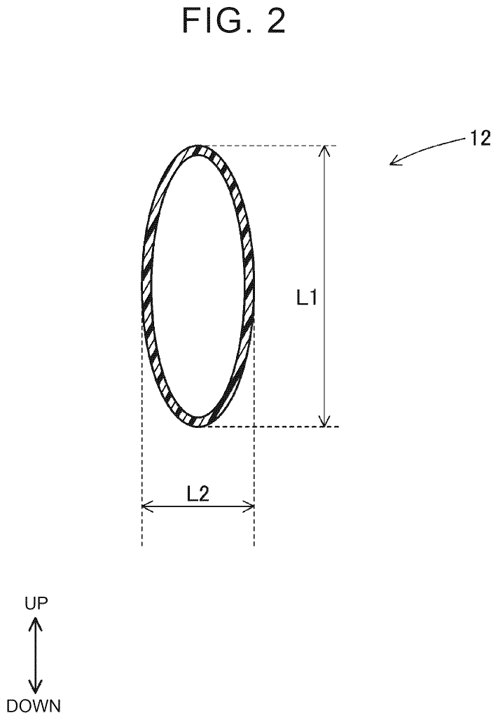

A pressure vessel 2 for fluid will be described with reference to FIGS. 1 and 2. As an example, the pressure vessel 2 is mounted on a fuel cell electric vehicle (not shown). The pressure vessel 2 is filled with high-pressure hydrogen gas that is used to generate electricity in the fuel cell electric vehicle.

As shown in FIG. 1, the pressure vessel 2 includes a plurality of main body portions 10 and a plurality of bent portions 12. For convenience, in the following description, the direction in which the main body portions 10 are lined up will be referred to as the “left-right direction”, and the longitudinal direction of the main body portions 10, that is, the direction orthogonal to the left-right direction, will be referred to as the “front-rear direction”.

Each of the main body portions 10 extends along the front-rear direction. Each of the main body portions 10 has a tubular shape. The main body portion 10 includes a cylindrical portion 20, a first tapered portion 22, and a second tapered portion 24. The cylindrical portion 20 extends parallel to the front-rear direction. The cylindrical portion 20 has a cylindrical shape. The first tapered portion 22 is connected to the front end portion of the cylindrical portion 20. The first tapered portion 22 is inclined so that the dimension in the left-right direction becomes smaller toward the front side. The dimension of the first tapered portion 22 in an up-down direction is constant in the front-rear direction. The second tapered portion 24 is connected to the rear end portion of the cylindrical portion 20. The second tapered portion 24 is inclined so that the dimension in the left-right direction becomes smaller toward the rear side. The dimension of the second tapered portion 24 in the up-down direction is constant in the front-rear direction.

Each of the bent portions 12 has a tubular shape. Among the bent portions 12, each bent portion 12 located on the front side of the pressure vessel 2 extends between the front end portions of two adjacent main body portions 10 among the main body portions 10. For example, the rightmost bent portion 12 on the front side of the pressure vessel 2 extends forward from the front end portion of the rightmost main body portion 10, then bends and extends to the left, and bends further to extend to the front end portion of the adjacent main body portion 10.

Among the bent portions 12, each bent portion 12 located on the rear side of the pressure vessel 2 extends between the rear end portions of two adjacent main body portions 10 among the main body portions 10. For example, the rightmost bent portion 12 on the rear side of the pressure vessel 2 extends rearward from the rear end portion of the second main body portion 10 from the right, then bends and extends to the left, and bends further to extend to the rear end portion of the adjacent main body portion 10. The flow path axis of the bent portion 12 in FIG. 1 has a semicircular arc shape.

The bent portion 12 is connected to the front end portion of the main body portion 10 located on the rightmost side and the front end portion of the main body portion 10 located on the leftmost side, and the bent portion 12 is connected to both of the front and rear end portions of other main body portions 10. In this manner, the main body portions 10 are connected in series by the bent portions 12.

As shown in FIG. 2, the cross-sectional shape perpendicular to the extension direction of the bent portion 12 is elliptical. Hereinafter, the cross-sectional shape and the cross section perpendicular to the extension direction will be simply referred to as the “cross-sectional shape” and the “cross section”, respectively. The major axis direction of the elliptical shape is parallel to the up-down direction. The minor axis direction of the elliptical shape is a direction orthogonal to the up-down direction and the extension direction of the bent portion 12 (hereinafter, referred to as the “flow path width direction”). That is, in the cross-sectional shape of the bent portion 12, a dimension L1 in the up-down direction is larger than a dimension L2 in the flow path width direction. The dimension L1 in the up-down direction is substantially the same as the outer diameter of the cylindrical portion 20 of the main body portion 10.

### Manufacturing Method of Pressure Vessel 2

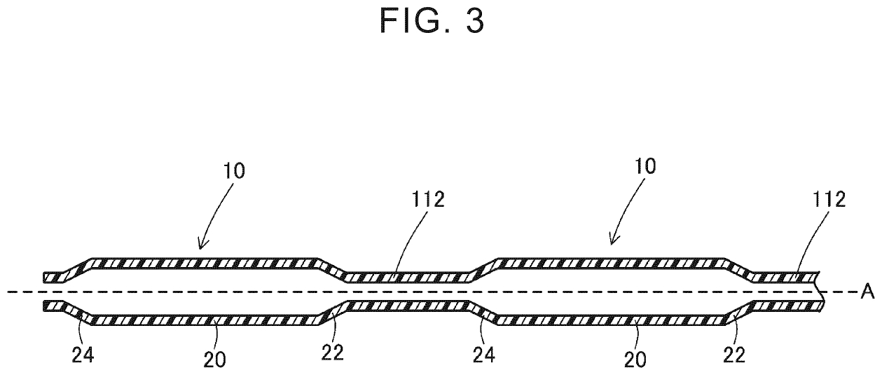

A manufacturing method of the pressure vessel 2 will be described with reference to FIG. 3.

First, as shown in FIG. 3, a tubular member 102 is provided along an axis A direction. As an example, the tubular member 102 is integrally provided by extrusion molding. The tubular member 102 includes the main body portions 10 and a plurality of tubular portions 112. The cross-sectional shape of the tubular portion 112 is the same as the cross-sectional shape (see FIG. 2) of the bent portion 12 (see FIG. 1). That is, the cross-sectional shape of the tubular portion 112 is elliptical.

Next, the tubular portions 112 are bent to provide the bent portions 12 (see FIG. 1). In this manner, the pressure vessel 2 shown in FIG. 1 is manufactured.

As described above, the bent portion 12 (see FIG. 1) is provided by bending the tubular portion 112. However, if the cross-sectional shape of the tubular portion 112 is the same specific circle as the cross-sectional shape of the cylindrical portion 20 of the main body portion 10, relatively large force would be required to bend the tubular portion 112. For this reason, it is desirable for the tubular portion 112 to be provided with a cross-sectional shape that is easy to bend. Therefore, the dimension L2 of the tubular portion 112 in the flow path width direction is smaller than the outer diameter of the cylindrical portion 20. This allows the tubular portion 112 to be bent more easily than when the cross-sectional shape of the tubular portion 112 is the specific circle.

### Effects of Embodiment

As described above, the pressure vessel 2 includes the plurality of main body portions 10, each having a tubular shape extending along the front-rear direction (an example of a “first direction”) and disposed along the left-right direction (an example of a “second direction”), and the plurality of bent portions 12, each having a tubular shape, extending between two adjacent end portions of the main body portions 10, and connecting the main body portions 10 in series. The cross-sectional shape perpendicular to the extension direction of the bent portions 12 is such that the dimension L1 in the up-down direction (an example of a “third direction”) is larger than the dimension L2 in the flow path width direction (an example of a “fourth direction”). In particular, in the present embodiment, the cross-sectional shape is elliptical.

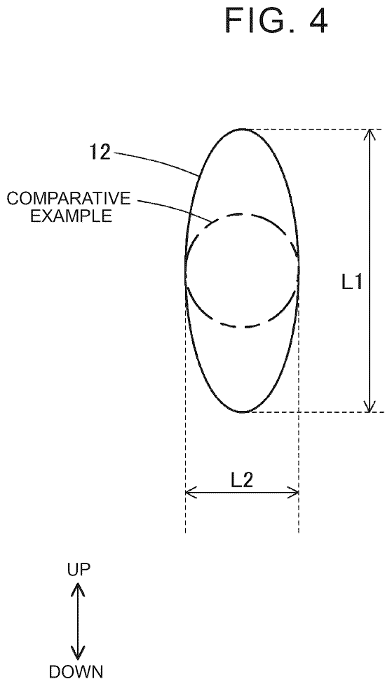

According to the above configuration, as shown in FIG. 4, the cross-sectional area of the bent portions 12 is able to be made larger than in the configuration in which the cross-sectional shape of the bent portions 12 is the specific circle (a comparative example in FIG. 4). Therefore, it is possible to increase the amount of fluid that is able to be filled into the pressure vessel 2.

Further, compared to the configuration in which the cross-sectional shape of the bent portions 12 is the specific circle, a decrease in fluid velocity at the bent portions 12 is able to be suppressed.

### Second Embodiment

A pressure vessel in a second embodiment will be described. In the pressure vessel of the second embodiment, the cross-sectional shape of a bent portion 212 in FIG. 4 is different from the cross-sectional shape of the bent portion 12 in the first embodiment.

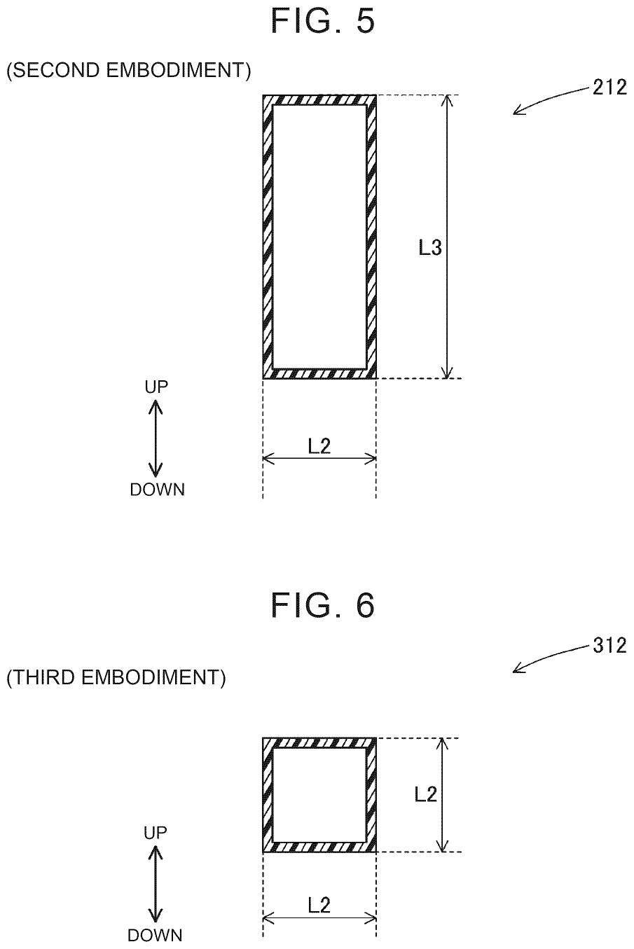

As shown in FIG. 5, the cross-sectional shape of the bent portion 212 is rectangular. The longitudinal direction of the rectangular shape is parallel to the up-down direction. The short direction of the rectangular shape is parallel to the flow path width direction of the bent portion 212. That is, in the cross-sectional shape, a dimension L3 in the up-down direction is larger than the dimension L2 in the flow path width direction. The dimension L3 in the up-down direction is substantially the same as the outer diameter of the cylindrical portion 20 of the main body portion 10.

The above configuration is also able to provide the same effects as the first embodiment.

### Third Embodiment

A pressure vessel in a third embodiment will be described. In the pressure vessel of the third embodiment, the cross-sectional shape of a bent portion 312 in FIG. 6 is different from the cross-sectional shape of the bent portion 12 in the first embodiment.

As shown in FIG. 6, the cross-sectional shape perpendicular to the extension direction of the bent portion 312 is square. The dimension L2 of one side of the square shape is smaller than the outer diameter of the cylindrical portion 20 of the main body portion 10.

According to the above configuration, the cross-sectional area of the bent portion 312 is able to be made larger than in the configuration in which the cross-sectional shape of the bent portion 312 is the specific circle. Therefore, it is possible to increase the amount of fluid that is able to be filled into the pressure vessel 2.

Although the embodiments have been described in detail above, these are merely examples and do not limit the scope of the claims. The technique described in the claims includes various modifications and variations of the specific examples exemplified above.

### First Modification

The number of the main body portions 10 lined up in the left-right direction may be two to five, or may be seven or more.

### Second Modification

The cross-sectional shape of the main body portion 10 is not limited to circular, but may be quadrilateral or elliptical.

### Third Modification

The outer peripheral edge of the bent portions 12, 212, 312 may have a bellows shape.

The technical elements described in the present specification or in the drawings exhibit technical usefulness alone or in various combinations, and are not limited to the combinations described in the claims at the time of filing the application. In addition, the technique exemplified in the present specification or drawings can achieve a plurality of purposes at the same time, and achieving one of the purposes itself has technical usefulness.

What is claimed is:

1. A pressure vessel for fluid, the pressure vessel comprising:
a plurality of main body portions, each having a tubular shape extending along a first direction and disposed along a second direction orthogonal to the first direction; and
one or more bent portions, each having a tubular shape, extending between two adjacent end portions of the main body portions, and connecting the main body portions in series, wherein
a cross-sectional shape of the bent portion perpendicular to an extension direction is a shape in which a dimension in a third direction orthogonal to the first direction and the second direction is larger than a dimension in a fourth direction orthogonal to the third direction.

2. The pressure vessel according to claim 1, wherein the cross-sectional shape is oval or elliptical.

3. The pressure vessel according to claim 1, wherein the cross-sectional shape is rectangular.

4. A pressure vessel for fluid, the pressure vessel comprising:
a plurality of main body portions, each having a tubular shape extending along a first direction and disposed along a second direction orthogonal to the first direction; and
one or more bent portions, each having a tubular shape, extending between two adjacent end portions of the main body portions, and connecting the main body portions in series, wherein
a cross-sectional shape of the bent portion perpendicular to an extension direction is a square shape in which a dimension in a third direction orthogonal to the first direction and the second direction is equal to a dimension in a fourth direction orthogonal to the third direction.
